(19) United States
(12) Patent Application Publication
(10) Pub. No.: US 2026/0312963 A1
(43) Pub. Date: Oct. 8, 2026

(54) METHOD OF DETECTING SECURITY THREAT TO NETWORK AND ELECTRONIC DEVICE FOR PERFORMING THE SAME

(71) Applicant: Gumi Electronics & Information Technology Research Institute, Gumi-si (KR)

(72) Inventors: Mahnsuk YOON, Gumi-si (KR); Jaeuk KWON, Gumi-si (KR)

(21) Appl. No.: 19/353,345

(22) Filed: Oct. 8, 2025

(30) Foreign Application Priority Data
Dec. 17, 2024 (KR) 10-2024-0188907

(51) Int. Cl. H04L 9/40; H04L 43/045

(52) U.S. Cl. CPC H04L 63/1416; H04L 43/045; H04L 63/102; H04L 63/1466

(57) ABSTRACT

A method of detecting a security threat to a network is provided. The method includes obtaining an access data packet from a target electronic device that is to access a electronic device included in the network, based on the access data packet, determining whether the target electronic device matches at least one of registration profiles included in a profile set prestored in the electronic device, when the target electronic device fails to match the registration profiles, determining that a security threat occurs in the network, when the target electronic device matches a registration profile among the registration profiles, obtaining target information regarding access of the target electronic device to the network, based on the target information, determining whether a constraint of the registration profile is satisfied, and when it is determined that the constraint of the registration profile is unsatisfied, determining that a security threat occurs in the network.

### CROSS-REFERENCE TO RELATED APPLICATION

This application claims the benefit of Korean Patent Application No. 10-2024-0188907, filed on Dec. 17, 2024, in the Korean Intellectual Property Office, the entire disclosure of which is incorporated herein by reference for all purposes.

### BACKGROUND

### 1. Field of the Invention

One or more embodiments relate to technology for detecting a security threat to a network, and more particularly, to technology for detecting a security threat to a network based on a data packet obtained from an electronic device accessing the network.

### 2. Description of the Related Art

In industrial environments such as smart factories, heterogeneous mobile communication networks may be used, interconnecting various terminals and servers, such as industrial Internet of Things (IoT) devices, image collection devices, and service servers. To maintain compatibility between a plurality of electronic devices within a network and manage the network, the heterogeneous mobile communication networks may include electronic devices supporting an application programming interface (API).

To maintain the security of the heterogeneous mobile communication networks, a method is required that allows API-supporting electronic devices to detect anomalies or security threats in various electronic devices accessing the network.

### SUMMARY

Embodiments provide an electronic device capable of detecting a security threat to a network based on a data packet obtained from a target electronic device accessing a network.

Embodiments provide an electronic device capable of detecting a security threat to a network based on information regarding access of a target electronic device to a network for a predetermined period.

However, the technical goals are not limited to the foregoing goals, and there may be other technical goals.

According to an aspect, there is provided a method of detecting a security threat to a network, performed by an electronic device, the method including obtaining an access data packet from a target electronic device that is to access a first electronic device included in the network, based on the access data packet, determining whether the target electronic device matches at least one of registration profiles included in a profile set prestored in the electronic device, when the target electronic device fails to match the registration profiles, determining that a security threat occurs in the network, when the target electronic device matches a first registration profile among the registration profiles, obtaining target information regarding access of the target electronic device to the network, based on the target information, determining whether a constraint of the first registration profile is satisfied, and when it is determined that the constraint of the first registration profile is unsatisfied, determining that a security threat occurs in the network.

The first registration profile may include at least one of a type of the target electronic device, an operating entity of the target electronic device, Internet Protocol (IP) information of the target electronic device, an identification number of the target electronic device, or the constraint of the target electronic device.

The target information may include at least one of an access cycle of the target electronic device to the network or the first electronic device, a number of times the target electronic device accesses the network or the first electronic device during a preset first period, or an amount of data transmitted to the network or the first electronic device.

The method may further include outputting, through an administrator terminal, an image obtained by visualizing the target information corresponding to each of preset periods.

The method may further include, when it is determined that a security threat occurs in the network, transmitting, to an administrator terminal, a notification indicating that a security threat occurs in the network and blocking a data packet from the target electronic device for a first time period.

The method may further include, when it is determined that the constraint of the first registration profile is satisfied, transmitting, to the first electronic device, the access data packet or a data packet converted corresponding to the first electronic device.

According to another aspect, there is provided an electronic device including at least one processor including processing circuitry and a memory including one or more storage media storing instructions, wherein the instructions, when executed by the at least one processor individually or collectively, may cause the electronic device to at least obtain an access data packet from a target electronic device that is to access a first electronic device included in a network, based on the access data packet, determine whether the target electronic device matches at least one of registration profiles included in a profile set prestored in the electronic device, when the target electronic device fails to match the registration profiles, determine that a security threat occurs in the network, when the target electronic device matches a first registration profile among the registration profiles, obtain target information regarding access of the target electronic device to the network, based on the target information, determine whether a constraint of the first registration profile is satisfied, and when it is determined that the constraint of the first registration profile is unsatisfied, determine that a security threat occurs in the network.

According to another aspect, there is provided a method of detecting a security threat to a heterogeneous mobile communication network, performed by an electronic device, the method including obtaining an access data packet from a target electronic device that is to access a first electronic device included in a network including a plurality of electronic devices configured to operate with different communication protocols, based on the access data packet, determining whether the target electronic device matches at least one of registration profiles included in a profile set prestored in the electronic device, when the target electronic device fails to match the registration profiles, determining that a security threat occurs in the network, when the target electronic device matches a first registration profile among the registration profiles, obtaining target information regarding access of the target electronic device to the network, based on the target information, determining whether a constraint of the first registration profile is satisfied, when it is determined that the constraint of the first registration profile is unsatisfied, determining that a security threat occurs in the network, and when it is determined that the constraint of the first registration profile is satisfied, transmitting, to the first electronic device, the access data packet or a data packet converted corresponding to the first electronic device.

The first registration profile may include at least one of a type of the target electronic device, an operating entity of the target electronic device, IP information of the target electronic device, an identification number of the target electronic device, or the constraint of the target electronic device.

The target information may include at least one of an access cycle of the target electronic device to the network or the first electronic device, a number of times the target electronic device accesses the network or the first electronic device during a preset first period, or an amount of data transmitted to the network or the first electronic device.

The method may further include outputting, through an administrator terminal, an image obtained by visualizing the target information corresponding to each of preset periods.

The method may further include, when it is determined that a security threat occurs in the network, transmitting, to an administrator terminal, a notification indicating that a security threat occurs in the network and blocking a data packet from the target electronic device for a first time period.

According to another aspect, there is provided an electronic device including at least one processor including processing circuitry and a memory including one or more storage media storing instructions, wherein the instructions, when executed by the at least one processor individually or collectively, may cause the electronic device to at least obtain an access data packet from a target electronic device that is to access a first electronic device included in a network including a plurality of electronic devices operating with different communication protocols, based on the access data packet, determine whether the target electronic device matches at least one of registration profiles included in a profile set prestored in the electronic device, when the target electronic device fails to match the registration profiles, determine that a security threat occurs in the network, when the target electronic device matches a first registration profile among the registration profiles, obtain target information regarding access of the target electronic device to the network, based on the target information, determine whether a constraint of the first registration profile is satisfied, when it is determined that the constraint of the first registration profile is unsatisfied, determine that a security threat occurs in the network, and when it is determined that the constraint of the first registration profile is satisfied, transmit, to the first electronic device, a data packet converted corresponding to the first electronic device.

Additional aspects of embodiments will be set forth in part in the description which follows and, in part, will be apparent from the description, or may be learned by practice of the disclosure.

According to an embodiment, an electronic device capable of detecting a security threat to a network may be provided by determining, based on a data packet obtained from a target electronic device accessing a network, whether the target electronic device matches registration profiles included in a profile set prestored in the electronic device.

According to an embodiment, an electronic device capable of detecting a security threat to a network may be provided by generating information regarding access of a target electronic device to a network over a predetermined period of time and comparing the information regarding the access of the target electronic device to the network with a constraint included in a registration profile.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 is a configuration of a network according to an embodiment;

FIG. 2 is a configuration of a monitoring device according to an embodiment;

FIG. 3 is a flowchart of a method of detecting a security threat to a network, according to an embodiment;

FIG. 4 is a flowchart of a method of outputting an image obtained by visualizing access information for a network, according to an embodiment;

FIG. 5 is an image obtained by visualizing access information for a network, according to an embodiment;

FIG. 6 is a flowchart of a method of responding to a security threat detected in a network, according to an embodiment;

FIG. 7 is a flowchart of a method of transmitting a received data packet to an electronic device of a network, according to an embodiment; and

FIG. 8 is a flowchart illustrating a method of detecting a security threat in a heterogeneous mobile communication network, according to an embodiment.

### DETAILED DESCRIPTION

Hereinafter, embodiments will be described in detail with reference to the accompanying drawings. However, various alterations and modifications may be made to the embodiments. Here, the embodiments are not construed as limited to the disclosure. The embodiments should be understood to include all changes, equivalents, and replacements within the idea and the technical scope of the disclosure.

The terminology used herein is for the purpose of describing particular embodiments only and is not to be limiting of the embodiments. The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, components, or groups thereof, but do not preclude the presence or addition of one or more other features, integers, steps, operations, elements, components, or groups thereof.

Unless otherwise defined, all terms including technical and scientific terms used herein have the same meaning as commonly understood by one of ordinary skill in the art to which embodiments belong. Terms, such as those defined in commonly used dictionaries, are to be interpreted as having a meaning that is consistent with their meaning in the context of the relevant art and the present disclosure, and are not to be interpreted in an idealized or overly formal sense unless expressly so defined herein.

When describing the embodiments with reference to the accompanying drawings, like reference numerals refer to like components and a repeated description related thereto will be omitted. In the description of embodiments, detailed description of well-known related structures or functions will be omitted when it is deemed that such description will cause ambiguous interpretation of the present disclosure.

Also, in the description of the components, terms such as first, second, A, B, (a), (b) or the like may be used herein when describing components of the present disclosure. These terms are used only for the purpose of discriminating one component from another component, and the nature, the sequences, or the orders of the components are not limited by the terms. When one component is described as being “connected”, “coupled”, or “attached” to another component, it should be understood that one component may be connected or attached directly to another component, and an intervening component may also be “connected”, “coupled”, or “attached” to the Components.

The same name may be used to describe an element included in the embodiments described above and an element having a common function. Unless stated otherwise, the description of an embodiment may be applicable to other embodiments, and a repeated description related thereto is omitted.

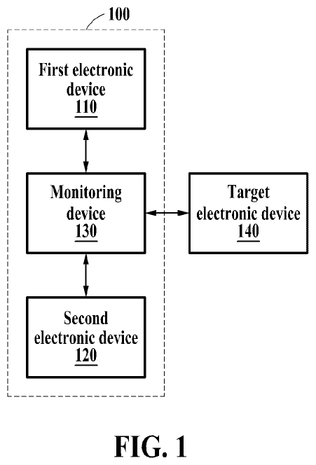

FIG. 1 is a configuration of a network according to an embodiment.

A network 100 according to an embodiment may include a first electronic device 110, a second electronic device 120, and a monitoring device 130. For example, the network 100 may include a plurality of electronic devices 110, 120, and 130 and connections between the plurality of electronic devices 110, 120, and 130. For example, the connections between the plurality of electronic devices 110, 120, and 130 may be wired or wireless communication in which data may be transmitted and received between the plurality of electronic devices 110, 120, and 130 based on a predetermined communication protocol. For example, the network 100 may be an industrial 5th generation (5G) specialized network (e.g., smart factory). For example, the network 100 may operate in a wireless communication system based on the 3rd generation partnership project (3GPP).

The first electronic device 110 or the second electronic device 120 may be an electronic device that is included in the network 100 and performs each function to implement the functions of the network 100 overall. For example, when the network 100 is a network that implements a smart factory environment, the first electronic device 110 or the second electronic device 120 may be any one of an industrial Internet of Things (IoT) device, an image collection device, a service server, or a administrator terminal of the network 100. For example, when the network 100 is a network that implements a smart home environment, the first electronic device 110 or the second electronic device 120 may be any one of a home IoT device, an image collection device, or a administrator terminal of the network 100.

An operation of each of the plurality of electronic devices 110 and 120 within the network 100 and the connection between the plurality of electronic devices 110 and 120 may be monitored through the monitoring device 130. For example, the monitoring device 130 may be an electronic device that supports an application programming interface (API). For example, the monitoring device 130 may obtain a data packet transmitted and received between the plurality of electronic devices 110 and 120 by mirroring the data packet. For example, the monitoring device 130 may directly obtain a data packet from one of the plurality of electronic devices 110 and 120 and transmit the obtained data packet or a converted data packet to the other of the plurality of electronic devices 110 and 120.

According to an embodiment, the network may be a heterogeneous mobile communication network including a plurality of electronic devices operating with different communication protocols. For example, when the first electronic device 110 and the second electronic device 120 operate with different communication protocols and the first electronic device 110 is to transmit data to the second electronic device 120, the monitoring device 130 may generate a data packet by converting a data packet obtained from the first electronic device 110 to correspond to a communication protocol of the second electronic device 120 and transmit the converted data packet to the second electronic device 120. As the plurality of electronic devices 110 and 120 within the network 100 communicates through the monitoring device 130, the network 100 having compatibility between the plurality of electronic devices 110 and 120 operating with different communication protocols may be implemented.

According to an embodiment, the monitoring device 130 may obtain a data packet from a target electronic device 140 that is to access the plurality of electronic devices 110 and 120 within the network 100. The monitoring device 130 may detect a security threat to the network 100 by identifying access from an electronic device outside the network 100 based on the data packet. For example, the security threat to the network 100 may be a phenomenon in which an excessive load is generated on an electronic device within the network 100 that processes network traffic due to abnormal access (e.g., an excessive number or volume of accesses) from a predetermined external device.

For example, the monitoring device 130 may obtain a data packet received from the target electronic device 140 by mirroring a data packet obtained by each of the plurality of electronic devices 110 and 120. For example, the monitoring device 130 may directly obtain a data packet from the target electronic device 140 that is to access at least one of the plurality of electronic devices 110 and 120. When the monitoring device 130 directly obtains a data packet from the target electronic device 140, the monitoring device 130 may transmit the data packet to the electronic devices 110 and 120 to be accessed by the target electronic device 140, since it is determined that the access of the target electronic device 140 is not a security threat to the network 100.

According to an embodiment, unlike the one illustrated, the monitoring device 130 may be any one of the plurality of electronic devices 110 and 120 within the network 100. The first electronic device 110 or the second electronic device 120 may monitor the network 100 by allocating some of available resources.

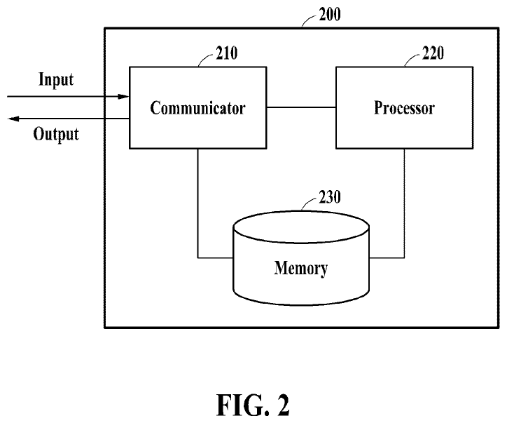

FIG. 2 is a configuration of a monitoring device according to an embodiment.

According to an embodiment, a monitoring device 200 (e.g., the monitoring device 130 of FIG. 1) may include a communicator 210, a processor 220, and a memory 230.

The communicator 210 may be connected to the processor 220, the memory 230, a plurality of electronic devices (e.g., the first electronic device 110 or the second electronic device 120 of FIG. 1) within a network (e.g., the network 100 of FIG. 1), and an external electronic device (e.g., the target electronic device 140 of FIG. 1) of the network to transmit and receive data. The communicator 210 may be connected to another external device to transmit and receive data. Hereinafter, transmitting and receiving “A” may refer to transmitting and receiving “information or data indicating A”.

The communicator 210 may be implemented as circuitry within the monitoring device 200. For example, the communicator 210 may include an internal bus and an external bus. In another example, the communicator 210 may be an element that connects the monitoring device 200 to an external device. The communicator 210 may be an interface. The communicator 210 may receive data from the external device and transmit data to the processor 220 and the memory 230.

The processor 220 may process data received by the communicator 210 and data stored in the memory 230. A “processor” may be a hardware-implemented data processing device having a circuit that is physically structured to execute desired operations. The desired operations may include code or instructions included in a program. For example, the hardware-implemented data processing device may include a microprocessor, a central processing unit (CPU), a processor core, a multi-core processor, a multiprocessor, an application-specific integrated circuit (ASIC), and a field-programmable gate array (FPGA).

The processor 220 may execute computer-readable code (e.g., software) stored in a memory (e.g., the memory 230) and instructions triggered by the processor 220. For example, a method of detecting a security threat to a network of the monitoring device 200 may be performed through execution of the instructions.

The memory 230 may store data received by the communicator 210 and data processed by the processor 220. For example, the memory 230 may store a program (or an application or software). The stored program may be a set of syntaxes executable by the processor 220 and coded to provide a method of detecting a security threat to a network.

According to an aspect, the memory 230 may include at least one volatile memory, non-volatile memory, random-access memory (RAM), flash memory, a hard disk drive, and an optical disc drive.

The memory 230 may store a set of instructions (e.g., software) for operating the monitoring device 200. The set of instructions for operating the monitoring device 200 may be executed by the processor 220.

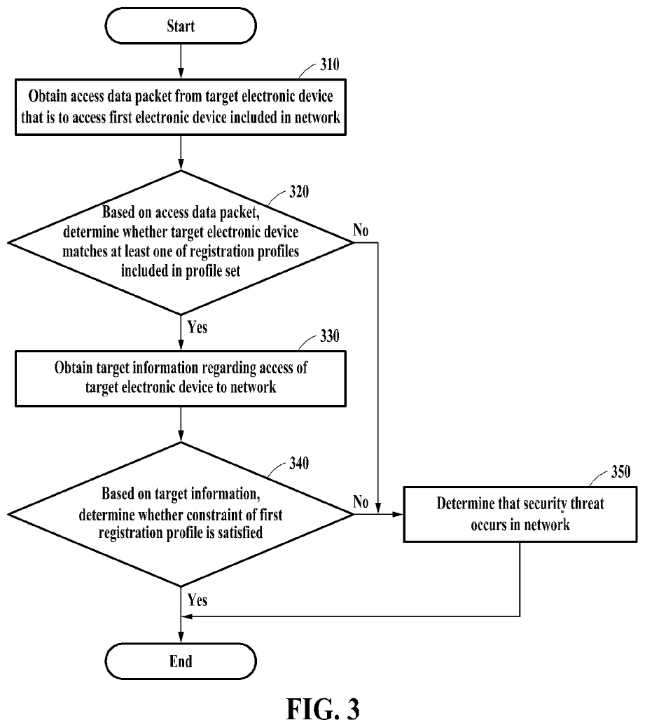

FIG. 3 is a flowchart of a method of detecting a security threat to a network, according to an embodiment.

Operations 310 to 350 may be performed by an electronic device (e.g., the monitoring device 130 of FIG. 1 or the monitoring device 200 of FIG. 2). The electronic device may include a communicator (e.g., the communicator 210 of FIG. 2), a processor (e.g., the processor 220 of FIG. 2), and a memory (e.g., the memory 230 of FIG. 2).

In operation 310, the electronic device may obtain an access data packet from a target electronic device (e.g., the target electronic device 140 of FIG. 1) that is to access a first electronic device (e.g., the first electronic device 110 or the second electronic device 120 of FIG. 1) included in a network (e.g., the network 100 of FIG. 1). For example, the access data packet may include information about the target electronic device from which the access data packet departs, information about the electronic device that the access data packet is destined for, information about a communication protocol, information to be transmitted to the electronic device to be destined, and information for checking for an error in a data packet.

According to an embodiment, the electronic device may be an electronic device that supports an API within the network. For example, a monitoring device may obtain a data packet received from a target electronic device by mirroring a data packet obtained by the first electronic device. For example, the monitoring device may directly obtain a data packet from a target electronic device that is to access the first electronic device.

In operation 320, based on the access data packet, the electronic device may determine whether the target electronic device matches at least one of registration profiles included in a profile set. For example, the profile set may be prestored in the electronic device that implements the method of detecting a security threat to a network. For example, the profile set may include registration profiles for respective electronic devices that are allowed or denied access to the network. For example, the profile set may include registration profiles for the respective electronic devices that are allowed or denied access, corresponding to the respective electronic devices included in the network.

According to an embodiment, a registration profile may be a policy for identifying and managing a network or one of the electronic devices that are allowed or denied access to a network. For example, the registration profile may include at least one of a type of an electronic device, an operating entity of the electronic device, Internet Protocol (IP) information of the electronic device, an identification number of the electronic device, or a constraint on the electronic device. For example, the registration profile may be input by a network administrator in advance. For example, the registration profile may be automatically generated for an electronic device that newly accesses the network. For example, the IP information of an electronic device may be designated as a single IP so that an electronic device corresponding to a single IP may be individually managed. For example, IP information of an electronic device may be designated as a subnet within a predetermined range so that at least one electronic device with a plurality of IPs may be managed by a single registration profile. For example, an identification number of an electronic device may be a media access control (MAC) address, a port number, an international mobile equipment identity (IMEI), an international mobile subscriber identity (IMSI), a virtual local area network (VLAN) tag, a user datagram protocol (UDP)/transmission control protocol (TCP) source port, an Internet Protocol version 6(IPv6) flow label, and the like. However, the identification number of an electronic device is not limited to the examples above, and the identification number of the electronic device may be various identifiers that may specify the electronic device according to a communication protocol of the electronic device.

According to an embodiment, based on at least one of a type of the target electronic device, an operating entity of the target electronic device, IP information of the target electronic device, or an identification number of the target electronic device obtained based on the access data packet, the electronic device may determine whether the target electronic device matches at least one of the registration profiles. For example, when there is a registration profile indicating the type of the electronic device, the operating entity of the electronic device, the IP information of the electronic device, or the identification number of the electronic device corresponding to at least one of the type of the target electronic device, the operating entity of the target electronic device, the IP information of the target electronic device, or the identification number of the target electronic device obtained based on the access data packet, the electronic device may determine that the target electronic device matches the registration profile.

In operation 330, when the target electronic device matches a first registration profile among the registration profiles, the electronic device may obtain target information regarding access of the target electronic device to the network (operation 320—Yes). For example, the target information may include at least one of a cycle of the target electronic device accessing the network or the first electronic device, the number of times the target electronic device accesses the network or the first electronic device during a preset unit period, or the amount of data transmitted to the network or the first electronic device. For example, the target information may indicate information accessed by the target electronic device corresponding to each of at least one electronic device in the network. For example, the target information may indicate information regarding the access of the target electronic device corresponding to all of a plurality of electronic devices included in the network.

According to an embodiment, the electronic device may output an image obtained by visualizing target information corresponding to each preset period through the administrator terminal. As a network administrator intuitively recognizes a network situation based on an output image, the network may be efficiently managed or a security threat may be promptly responded to.

In operation 340, based on the target information, the electronic device may determine whether an individually stored constraint is satisfied for an identified target electronic device.

According to an embodiment, the constraint may relate to whether the electronic device of the first registration profile is an electronic device permitted to access the network or the first electronic device. For example, when the target electronic device is an electronic device not permitted to access the network, the electronic device may determine that a security threat occurs in the network.

According to an embodiment, the constraint may relate to a cycle in which a data packet is received from the electronic device of the first registration profile. For example, when the first registration profile sets a cycle in which a data packet is received for the target electronic device, and the electronic device obtains an access data packet from the target electronic device outside of the cycle, the electronic device may determine that a network security threat occurs.

According to an embodiment, the constraint may relate to the number of times the electronic device of the first registration profile may access the network or the first electronic device during a preset unit period. For example, when the number of times the target electronic device may access the network or the first electronic device during a preset unit period is set in the first registration profile and when the number of times data packets are obtained from the target electronic device during the unit period exceeds the set number of times, the electronic device may determine that a security threat occurs in the network.

According to an embodiment, the constraint may relate to the amount of data that the electronic device of the first registration profile may transmit to the network or the first electronic device during the preset unit time. For example, the amount of data that the target electronic device may transmit to the network or the first electronic device during the preset unit time may be set in the first registration profile, and the electronic device may determine that a network security threat occurs when the amount of data transmitted from the target electronic device during the unit time exceeds the set amount of data.

The constraint that a registration profile may include is not limited to the embodiments described herein, and various constraints may be set for determining a network security threat. At least one of the described embodiments may be combined with other constraints. For example, the electronic device may determine whether a network security threat occurs based on the number of times that a data packet is obtained from the target electronic device during the unit time and the size of data transmitted from the target electronic device.

In operation 350, the electronic device may determine that a security threat occurs in the network when it is determined that the target electronic device fails to match the registration profiles or that the constraint of the first registration profile is unsatisfied (operation 320—No or operation 340—No).

According to an embodiment, the electronic device may automatically respond to a network security threat when it is determined that a security threat occurs in the network. For example, the electronic device may transmit, to the administrator terminal, a notification indicating that a security threat occurs in the network. For example, the electronic device may block a data packet from the target electronic device for a preset period of time.

According to an embodiment, when it is determined that the constraint of the first registration profile is satisfied, the electronic device may perform an operation corresponding to the access data packet (operation 340—Yes). For example, when the target electronic device is to access the first electronic device within the network, the electronic device may transmit, to the first electronic device, the access data packet or a data packet converted corresponding to the first electronic device. Even when the first electronic device operates with a different communication protocol from the target electronic device, the data that the target electronic device is to transmit may be accurately transmitted to the first electronic device by the operation of the electronic device. For example, when the target electronic device is to access a plurality of electronic devices within the network, the electronic device may transmit, to each of the plurality of electronic devices, a data packet converted corresponding to each of the plurality of electronic devices.

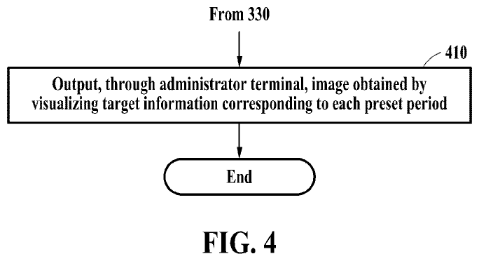

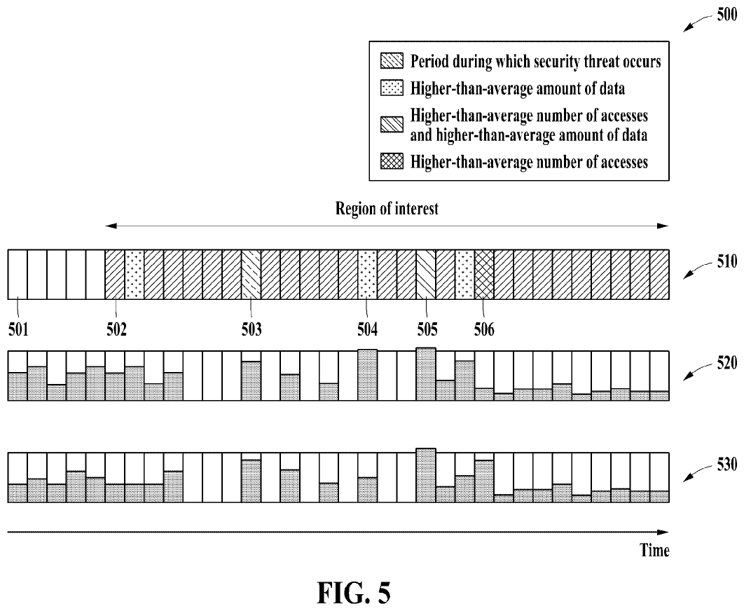

FIG. 4 is a flowchart of a method of outputting an image obtained by visualizing access information for a network, according to an embodiment. FIG. 5 is an image obtained by visualizing access information for a network, according to an embodiment.

Operation 410 may be performed by an electronic device (e.g., the monitoring device 130 of FIG. 1 or the monitoring device 200 of FIG. 2). The electronic device may include a communicator (e.g., the communicator 210 of FIG. 2), a processor (e.g., the processor 220 of FIG. 2), and a memory (e.g., the memory 230 of FIG. 2). For example, operation 410 may be performed after operation 330 described above with reference to FIG. 3 is performed.

In operation 410, the electronic device may output, through an administrator terminal, an image 500 obtained by visualizing target information corresponding to each preset period. For example, target information may include at least one of the number of times a target electronic device (e.g., the target electronic device 140 of FIG. 1) accesses a network (e.g., the network 100 of FIG. 1) during a preset unit period or the amount of data transmitted to the network. For example, the target information may be information regarding the access of the target electronic device corresponding to each of at least one electronic device (e.g., the first electronic device 110 or the second electronic device 120 of FIG. 1) of the network. For example, the target information may be information regarding the access of the target electronic device corresponding to all of a plurality of electronic devices included in the network. For example, the target electronic device may be a single electronic device or a group of electronic devices managed by the same policy.

Referring to FIG. 5, the image 500 obtained by visualizing the target information about the target electronic device accessing the network is shown. For example, the image 500 of FIG. 5 may include three columns (e.g., a first column 510, a second column 520, and a third column 530) showing respective values of a plurality of unit periods over time. The first column 510 may represent the overall security situation of the network in color. The second column 520 may represent the amount of data transmitted to the network by the target electronic device in a bar graph. The third column 530 may represent the number of times the target electronic device accesses the network in a bar graph.

For example, a first period 501 may be the earliest unit period in the image 500. The image 500 may not show the overall security situation of the first column 510 for a predetermined number of past unit periods that do not correspond to a region of interest but may only show target information in the second column 520 and the third column 530 so that target information in the region of interest may be compared to the past.

For example, a second period 502 may be a point in time at which the region of interest begins in the image 500. In the region of interest starting from the second period 502, information from the first column 510 to the third column 530 is fully displayed. In the second period 502, the amount of data in the second column 520 is lower than an average, and the number of accesses shown in the third column 530 is lower than an average, indicating that no network security threats occur.

For example, a third period 503 may be a period during which it is determined that a network security threat occurs. The electronic device may visually represent the relationship between target information obtained in response to the access of the target electronic device and the network security threat by displaying, in the first column 510, whether it is determined that the network security threat occurs.

For example, in a fourth period 504, the amount of data indicated in the second column 520 is higher than an average, and the number of accesses indicated in the third column 530 is lower than an average. Therefore, the first column 510 may indicate that the target electronic device accesses the network with a higher-than-average amount of data.

For example, in a fifth period 505, the amount of data indicated in the second column 520 is higher than the average, and the number of accesses indicated in the third column 530 is higher than the average. Therefore, the first column 510 may indicate that the target electronic device accesses the network with a higher-than-average number of accesses and a higher-than-average amount of data.

For example, in a sixth period 506, the amount of data indicated in the second column 520 is lower than the average, and the number of accesses indicated in the third column 530 is higher than the average. Therefore, the first column 510 may indicate that the target electronic device accesses the network with a higher-than-average number of accesses.

As a network administrator intuitively recognizes the network situation based on the output image 500, the network may be efficiently managed or a network security threat may be promptly addressed.

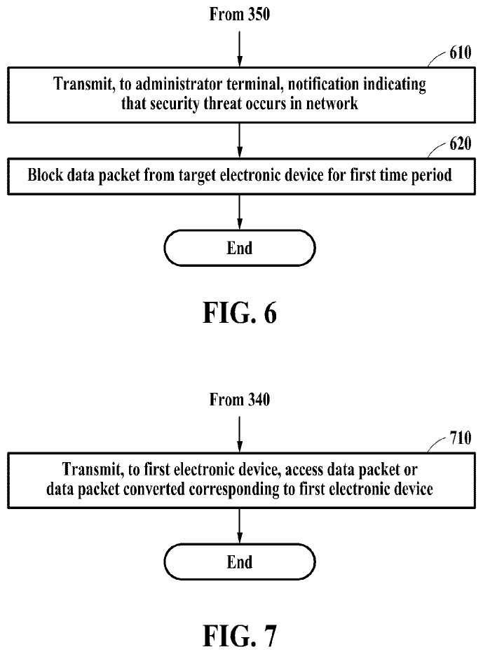

FIG. 6 is a flowchart of a method of responding to a security threat detected in a network, according to an embodiment.

Operations 610 and 620 may be performed by an electronic device (e.g., the monitoring device 130 of FIG. 1 or the monitoring device 200 of FIG. 2). The electronic device may include a communicator (e.g., the communicator 210 of FIG. 2), a processor (e.g., the processor 220 of FIG. 2), and a memory (e.g., the memory 230 of FIG. 2). For example, operations 610 and 620 may be performed after operation 350 described above with reference to FIG. 3 is performed.

According to an embodiment, when it is determined that a security threat occurs in a network (e.g., the network 100 of FIG. 1), the electronic device may automatically respond to the security threat occurring in the network.

In operation 610, the electronic device may transmit, to an administrator terminal, a notification indicating that a security threat occurs in the network.

In operation 620, the electronic device may block a data packet from a target electronic device (e.g., the target electronic device 140 of FIG. 1) for a first time period. The electronic device may prevent a network security incident by discarding an already obtained access data packet without transmitting the already obtained access data packet to a first electronic device (e.g., the first electronic device 110 or the second electronic device 120 of FIG. 1) or by blocking subsequent access by the target electronic device that causes a network security threat for a preset period of time.

According to an embodiment, the electronic device may generate a record indicating a situation leading to a determination that a network security threat occurs, a situation following the determination that the network security threat occurs, and an action taken in response to the network security threat. Based on this record, the network administrator may identify security vulnerabilities in the network or improve a method of responding to the network security threat.

FIG. 7 is a flowchart of a method of transmitting a received data packet to an electronic device of a network, according to an embodiment.

Operation 710 may be performed by an electronic device (e.g., the monitoring device 130 of FIG. 1 or the monitoring device 200 of FIG. 2). The electronic device may include a communicator (e.g., the communicator 210 of FIG. 2), a processor (e.g., the processor 220 of FIG. 2), and a memory (e.g., the memory 230 of FIG. 2). For example, operation 710 may be performed when it is determined that the constraint of the first registration profile is satisfied in operation 340 described above with reference to FIG. 3.

According to an embodiment, when it is determined that a constraint of a first registration profile is satisfied, the electronic device may perform an operation corresponding to an access data packet. For example, when a target electronic device (e.g., the target electronic device 140 of FIG. 1) is to access a first electronic device (e.g., the first electronic device 110 or the second electronic device 120 of FIG. 1) within a network (e.g., the network 100 of FIG. 1) via the electronic device, as it is determined that the access of the target electronic device is not a security threat to the network, the electronic device may transmit, to th first electronic device, the access data packet or a data packet converted corresponding to the first electronic device.

In operation 710, the electronic device may transmit, to the first electronic device, the access data packet or the data packet converted corresponding to the first electronic device. For example, when the target electronic device and the first electronic device operate with the same communication protocol, the access data packet may be transmitted to the first electronic device. For example, when the target electronic device and the first electronic device operate with different communication protocols, the data packet converted corresponding to the communication protocol of the first electronic device may be transmitted to the first electronic device.

According to an embodiment, the network may be a heterogeneous network including a plurality of electronic devices operating with different communication protocols. For example, a first electronic device and a second electronic device within the network may be electronic devices operating with different communication protocols. For example, when the first electronic device is to transmit data to the second electronic device, the electronic device may generate a data packet by converting a data packet obtained from the first electronic device to correspond to the communication protocol of the second electronic device and transmit the converted data packet to the second electronic device. As the plurality of electronic devices within the network communicate through the electronic device, a network having compatibility between the plurality of electronic devices operating with different communication protocols may be implemented.

Since the plurality of electronic devices within the network or the target electronic device that is to access the plurality of electronic devices within the network communicate via the electronic device, even when the first electronic device operates with a different communication protocol from the target electronic device or the second electronic device within the network, data that the target electronic device or the second electronic device is to transmit may be accurately transmitted to the first electronic device.

As the electronic device performs communication within the network and communication for accessing an electronic device within the network and also performs an operation of monitoring a security threat based on a communication flow of the network, a highly secure and compatible network may be realized. For example, when it is determined that a security threat occurs in the network, the electronic device may respond to the network security threat by directly blocking communication with the target electronic device causing the security threat.

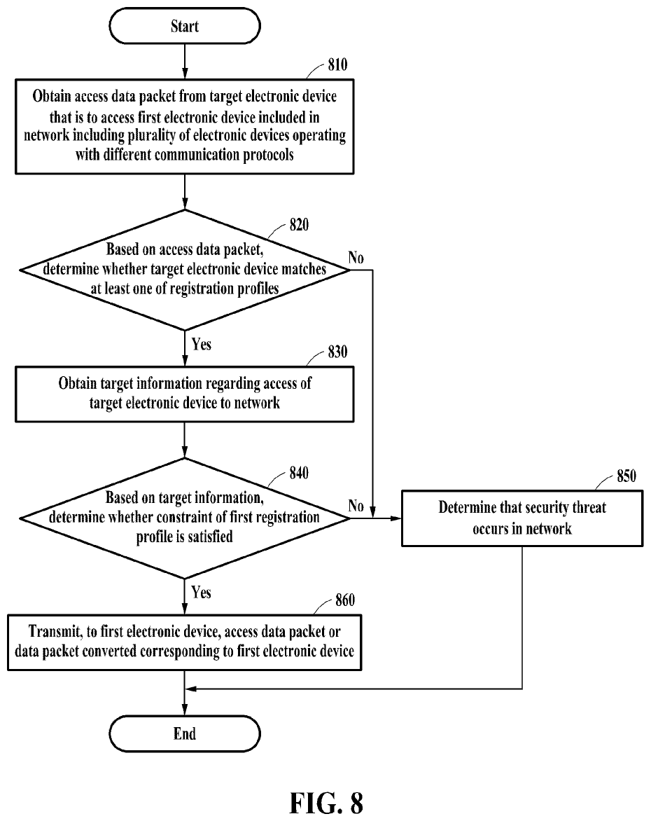

FIG. 8 is a flowchart illustrating a method of detecting a security threat in a heterogeneous mobile communication network, according to an embodiment.

Operations 810 to 860 may be performed by an electronic device (e.g., the monitoring device 130 of FIG. 1 or the monitoring device 200 of FIG. 2). The electronic device may include a communicator (e.g., the communicator 210 of FIG. 2), a processor (e.g., the processor 220 of FIG. 2), and a memory (e.g., the memory 230 of FIG. 2).

According to an embodiment, a network (e.g., the network 100 of FIG. 1) may be a heterogeneous mobile communication network including a plurality of electronic devices operating with different communication protocols. For example, the plurality of electronic devices within the network or a target electronic device that is to access the plurality of electronic devices within the network may communicate via the electronic device. Since communication within the network and communication accessing an electronic device within the network are performed via the electronic device, a network compatible with various communication protocols may be implemented.

In operation 810, the electronic device may obtain an access data packet from a target electronic device (e.g., the target electronic device 140 of FIG. 1) that is to access a first electronic device (e.g., the first electronic device 110 or the second electronic device 120 of FIG. 1) included in the network including the plurality of electronic devices operating with different communication protocols. The description of operation 310 described above with reference to FIG. 3 may similarly apply to the description of operation 810.

In operation 820, based on the access data packet, the electronic device may determine whether the target electronic device matches at least one of registration profiles included in a profile set. The description of operation 320 described above with reference to FIG. 3 may similarly apply to the description of operation 820.

In operation 830, when the target electronic device matches a first registration profile among the registration profiles, the electronic device may obtain target information regarding access of the target electronic device to the network (operation 830—Yes). The description of operation 330 described above with reference to FIG. 3 may similarly apply to the description of operation 830.

In operation 840, based on the target information, the electronic device may determine whether a constraint of the first registration profile is satisfied. The description of operation 340 described above with reference to FIG. 3 may similarly apply to the description of operation 840.

In operation 850, when the target electronic device fails to match the registration profiles or when it is determined that the constraint of the first registration profile is unsatisfied, the electronic device may determine that a security threat occurs in the network (operation 320—No or operation 340—No). The description of operation 350 described above with reference to FIG. 3 may similarly apply to the description of operation 850.

In operation 860, when it is determined that the constraint of the first registration profile is satisfied, the electronic device may transmit, to the first electronic device, the access data packet or a data packet converted corresponding to the first electronic device. For example, when the target electronic device is to access the plurality of electronic devices within the network, the electronic device may transmit, to each of the plurality of electronic devices, a data packet converted corresponding to each of the plurality of electronic devices.

As the electronic device for performing communication within the network and communication for accessing an electronic device within the network monitors a security threat based on a network communication flow, a network with high security and compatibility may be implemented. For example, when it is determined that a network security threat occurs, the electronic device may directly block communication with the target electronic device causing the security threat, thereby quickly responding to the network security threat.

The methods according to the embodiments described herein may be recorded in non-transitory computer-readable media including program instructions to implement various operations of the embodiments. The media may also include, alone or in combination with the program instructions, data files, data structures, and the like. The program instructions recorded on the media may be those specially designed and constructed for the purposes of embodiments, or they may be of the kind well-known and available to those having skill in the computer software arts. Examples of non-transitory computer-readable media include magnetic media such as hard disks, floppy disks, and magnetic tape; optical media such as compact disc read-only memory (CD-ROM) discs or DVDs; magneto-optical media such as optical discs; and hardware devices that are specially configured to store and perform program instructions, such as ROM, RAM, flash memory, and the like. Examples of program instructions include both machine code, such as produced by a compiler, and files containing higher-level code that may be executed by the computer using an interpreter. The hardware devices described above may be configured to act as one or more software modules in order to perform the operations of the embodiments, or vice versa.

Software may include a computer program, a piece of code, an instruction, or some combination thereof, to independently or collectively instruct or configure the processing device to operate as desired. The software and/or data may be embodied permanently or temporarily in any type of machine, component, physical or virtual equipment, computer storage medium or device, or in a propagated signal wave capable of providing instructions or data to or being interpreted by the processing device. The software also may be distributed over network-coupled computer systems so that the software is stored and executed in a distributed fashion. The software and data may be stored by one or more computer-readable recording mediums.

Although the embodiments have been described with reference to the limited drawings, one of ordinary skill in the art may apply various technical modifications and variations based thereon. For example, suitable results may be achieved if the described techniques are performed in a different order, and/or if components in a described system, architecture, device, or circuit are combined in a different manner, or replaced or supplemented by other components or their equivalents.

Therefore, other implementations, other embodiments, and equivalents to the claims are also within the scope of the following claims.

What is claimed is:

1. A method of detecting a security threat to a network, performed by an electronic device, the method comprising:
obtaining an access data packet from a target electronic device that is to access a first electronic device comprised in the network;
based on the access data packet, determining whether the target electronic device matches at least one of registration profiles comprised in a profile set prestored in the electronic device;
when the target electronic device fails to match the registration profiles, determining that a security threat occurs in the network;
when the target electronic device matches a first registration profile among the registration profiles, obtaining target information regarding access of the target electronic device to the network;
based on the target information, determining whether a constraint of the first registration profile is satisfied; and
when it is determined that the constraint of the first registration profile is unsatisfied, determining that a security threat occurs in the network.

2. The method of claim 1, wherein the first registration profile comprises least one of a type of the target electronic device, an operating entity of the target electronic device, Internet Protocol (IP) information of the target electronic device, an identification number of the target electronic device, or the constraint of the target electronic device.

3. The method of claim 1, wherein the target information comprises at least one of an access cycle of the target electronic device to the network or the first electronic device, a number of times the target electronic device accesses the network or the first electronic device during a preset first period, or an amount of data transmitted to the network or the first electronic device.

4. The method of claim 3, further comprising:
outputting, through an administrator terminal, an image obtained by visualizing the target information corresponding to each of preset periods.

5. The method of claim 1, further comprising, when it is determined that security threat occurs in the network:
transmitting, to an administrator terminal, a notification indicating that a security threat occurs in the network; and
blocking a data packet from the target electronic device for a first time period.

6. The method of claim 1, further comprising:
when it is determined that the constraint of the first registration profile is satisfied, transmitting, to the first electronic device, the access data packet or a data packet converted corresponding to the first electronic device.

7. A non-transitory computer-readable storage medium storing instructions that, when executed by a processor, cause the processor to perform the method of claim 1.

8. An electronic device comprising:
at least one processor comprising processing circuitry; and
a memory comprising one or more storage media storing instructions,
wherein the instructions, when executed by the at least one processor individually or collectively, cause the electronic device to at least:
obtain an access data packet from a target electronic device that is to access a first electronic device comprised in a network;
based on the access data packet, determine whether the target electronic device matches at least one of registration profiles comprised in a profile set prestored in the electronic device;
when the target electronic device fails to match the registration profiles, determine that a security threat occurs in the network;
when the target electronic device matches a first registration profile among the registration profiles, obtain target information regarding access of the target electronic device to the network;
based on the target information, determine whether a constraint of the first registration profile is satisfied; and
when it is determined that the constraint of the first registration profile is unsatisfied, determine that a security threat occurs in the network.

9. A method of detecting a security threat to a heterogeneous mobile communication network, performed by an electronic device, the method comprising:
obtaining an access data packet from a target electronic device that is to access a first electronic device comprised in a network comprising a plurality of electronic devices configured to operate with different communication protocols;
based on the access data packet, determining whether the target electronic device matches at least one of registration profiles comprised in a profile set prestored in the electronic device;
when the target electronic device fails to match the registration profiles, determining that a security threat occurs in the network;
when the target electronic device matches a first registration profile among the registration profiles, obtaining target information regarding access of the target electronic device to the network;
based on the target information, determining whether a constraint of the first registration profile is satisfied;
when it is determined that the constraint of the first registration profile is unsatisfied, determining that a security threat occurs in the network; and
when it is determined that the constraint of the first registration profile is satisfied, transmitting, to the first electronic device, the access data packet or a data packet converted corresponding to the first electronic device.

10. The method of claim 9, wherein the first registration profile comprises least one of a type of the target electronic device, an operating entity of the target electronic device, Internet Protocol (IP) information of the target electronic device, an identification number of the target electronic device, or the constraint of the target electronic device.

11. The method of claim 9, wherein the target information comprises at least one of an access cycle of the target electronic device to the network or the first electronic device, a number of times the target electronic device accesses the network or the first electronic device during a preset first period, or an amount of data transmitted to the network or the first electronic device.

12. The method of claim 11, further comprising:
outputting, through an administrator terminal, an image obtained by visualizing the target information corresponding to each of preset periods.

13. The method of claim 9, further comprising, when it is determined that security threat occurs in the network:
transmitting, to an administrator terminal, a notification indicating that a security threat occurs in the network; and
blocking a data packet from the target electronic device for a first time period.
